(19) United States
(12) Patent Application Publication
(10) Pub. No.: US 2014/0205787 A1
(43) Pub. Date: Jul. 24, 2014

(54) CUSHION CAPABLE OF EXHAUSTING HEAT AND MOISTURE

(71) Applicant: NOVA LEATHER ENTERPRISE CO., LTD., Taichung City (TW)

(72) Inventor: SU-FANG OU, Taichung City (TW)

(73) Assignee: NOVA LEATHER ENTERPRISE CO., LTD., Taichung City (TW)

(21) Appl. No.: 13/746,475

(22) Filed: Jan. 22, 2013

(51) Int. Cl. B32B 3/04; B32B 5/18

(52) U.S. Cl. CPC B32B 3/04; B32B 5/18
USPC 428/71

(57) ABSTRACT

A cushion capable of exhausting heat and moisture includes an airproof bottom fabric, a lumpy foam pad on top of the bottom fabric, and a face fabric on top of the foam pad. The face fabric and the bottom fabric are connected to form a peripheral lamination so that the foam pad is enclosed between the face fabric and the bottom fabric to constitute the cushion having a certain thickness. The cushion has a plurality of air exhaust apertures close to the peripheral lamination. When the cushion is applied to a backpack, the face fabric can absorb the heat and perspiration of a user. When the user acts to compress and restore the foam pad, air is exhausted and inhaled repeatedly through the exhaust apertures of the cushion to expel heat and perspiration so as to provide a cool and comfortable effect.

### BACKGROUND OF THE INVENTION

1. Field of the Invention

The present invention relates to a cushion capable of exhausting heat and moisture. The cushion can be applied to a backpack for absorbing vibration. The cushion has a face fabric to absorb the heat and perspiration of a user when the user exercises. When a middle foam pad of the cushion is compressed and restored, air is exhausted and inhaled repeatedly through exhaust apertures of the cushion to expel heat and perspiration so as to provide a cool and comfortable effect.

2. Description of the Prior Art

To consider comfort and protection for carrying a backpack, the backpack is provided with a foam pad, cushion or the like at the position to be contact with the user. Through the soft and resilient foam, the friction of the backpack is reduced and the user won't feel uncomfortable after a period of time. A better pad or cushion is provided with a meshed face fabric to be contact with the user. The meshed face fabric enhances the heat dissipation effect of the pad or cushion.

In fact, the meshes are blocked by the user during use. The heat and perspiration of the user are stored inside the cushion and unable to be exhausted outward and quickly so the heat dissipation effect is limited. The user will feel muggy and sweat when carrying the backpack. Accordingly, the inventor of the present invention has devoted himself based on his many years of practical experiences to solve these problems.

### SUMMARY OF THE INVENTION

The primary object of the present invention is to provide a cushion capable of exhausting heat and moisture. The cushion comprises an airproof bottom fabric, a lumpy foam pad on top of the bottom fabric, and a face fabric on top of the foam pad. The face fabric and the bottom fabric are connected to form a peripheral lamination so that the foam pad is enclosed between the face fabric and the bottom fabric to constitute the cushion having a certain thickness. The cushion has a plurality of air exhaust apertures close to the peripheral lamination of the face fabric and the bottom fabric. The face fabric is adapted to absorb heat and to exhaust perspiration of a user. During compression and restoration of the foam pad, air is exhausted and inhaled repeatedly through the exhaust apertures of the cushion to expel heat and perspiration.

Another object of the present invention is to provide a cushion capable of exhausting heat and moisture, wherein the face fabric is made of a fabric able to absorb moisture and to exhaust perspiration, so that the perspiration of the user and moisture can be absorbed by the face fabric and exhausted through the exhaust apertures disposed at the side of the cushion. The cushion provides a dry and comfortable effect.

A further object of the present invention is to provide a cushion capable of exhausting heat and moisture, wherein, the cushion composed of the airproof bottom fabric, the foam pad and the face fabric can be applied to a backpack to exhaust heat and moisture automatically.

### BRIEF DESCRIPTION OF THE DRAWINGS

FIG. 1 is an exploded view of the present invention;

FIG. 1A is a partial enlarged view of FIG. 1;

FIG. 2 is a perspective view of the present invention;

FIG. 3-A is a sectional view of the present invention;

FIG. 3-B is a perspective view of the present invention when in use;

FIG. 3-C is another perspective view of the present invention when in use;

FIG. 4-A is a schematic view of an embodiment of the present invention; and

FIG. 4-B is another schematic view of the embodiment of the present invention.

### DETAILED DESCRIPTION OF THE PREFERRED EMBODIMENTS

Embodiments of the present invention will now be described, by way of example only, with reference to the accompanying drawings.

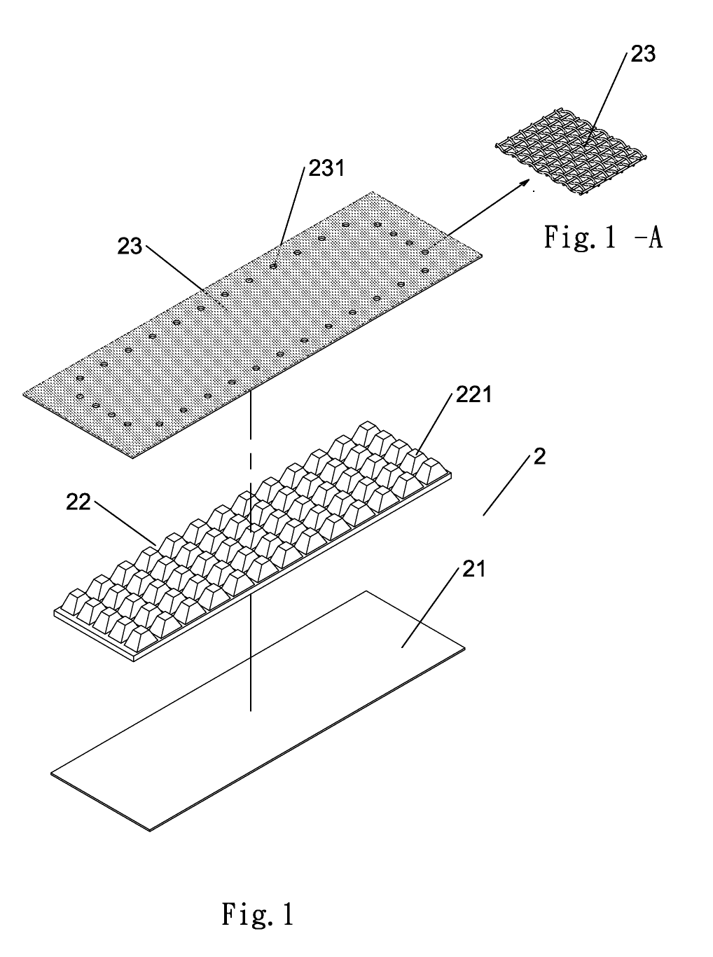

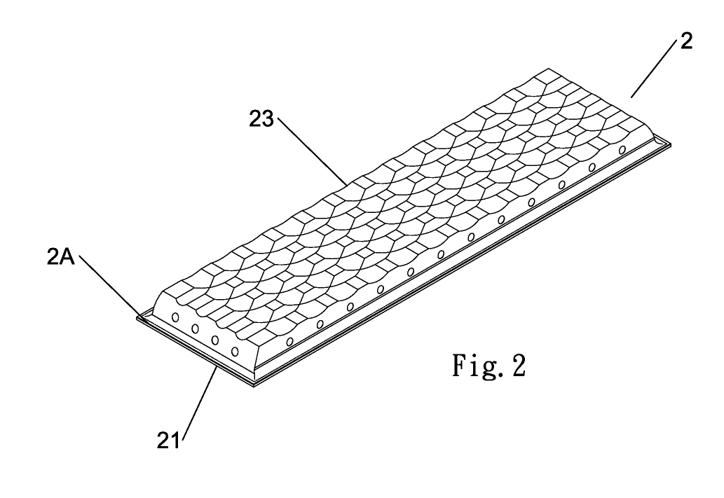

As shown in FIG. 1, FIG. 1-A and FIG. 2, the cushion 2 of the present invention comprises a bottom fabric 21, a foam pad 22, and a face fabric 23.

The bottom fabric 21 is made of an airproof material, such as plastic fabric.

The foam pad 22 corresponds in shape to the bottom fabric 21, and the size of the foam pad 22 is slightly smaller than that of the bottom fabric 21. The foam pad 22 is disposed on top of the bottom fabric 21. Wherein, the foam pad 22 has a lumpy top portion 22. The concave of the lumpy top portion 221 is adapted to increase the volume of air A to enhance the compression effect.

The face fabric 23 is able to absorb moisture and to exhaust perspiration, for example a fabric woven by superfine fibers. The face fabric 23 is disposed on top of the foam pad 22. The face fabric 23 and the bottom fabric 21 are connected by sewing or other pressing ways (such as high frequency, supersonic or the like) to form a peripheral lamination 2A so that the foam pad 22 is enclosed between the face fabric 23 and the bottom fabric 21 to constitute the cushion 2 having a certain thickness. The cushion 2 has a plurality of air exhaust apertures 231 close to the peripheral lamination 2A of the face fabric 23 and the bottom fabric 21.

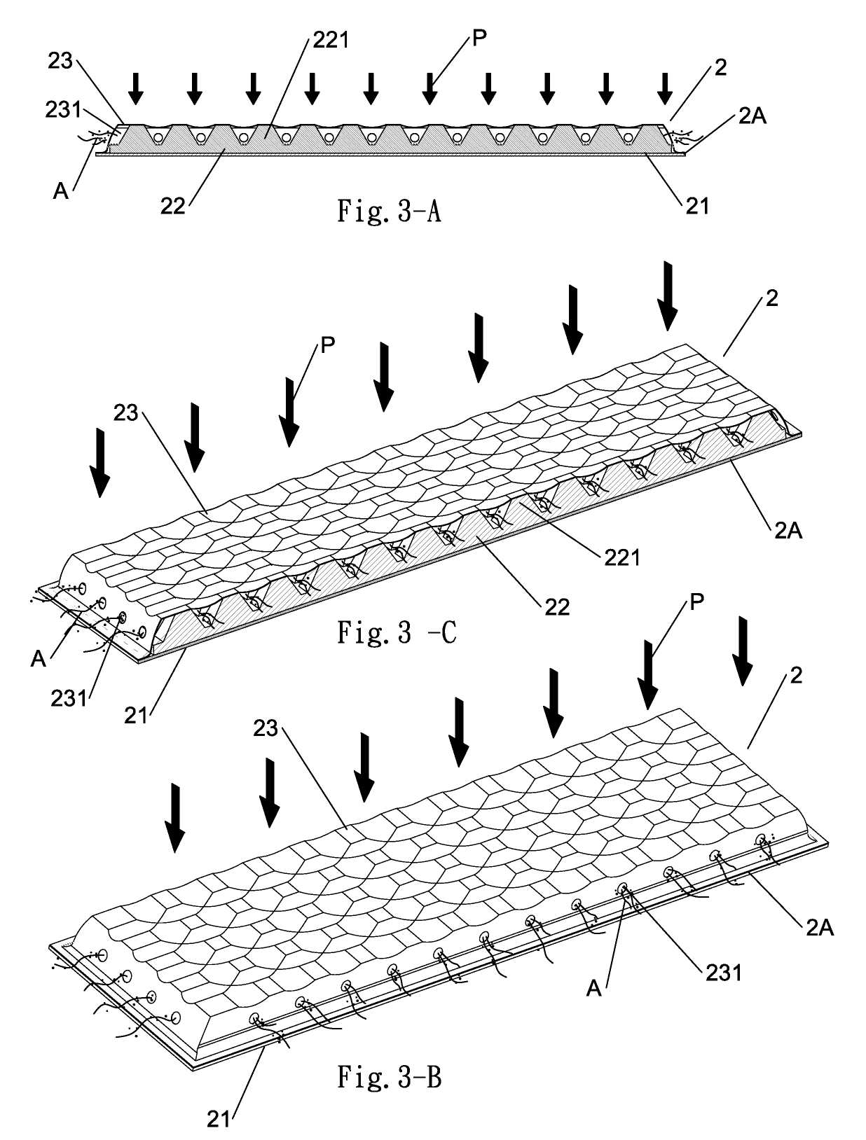

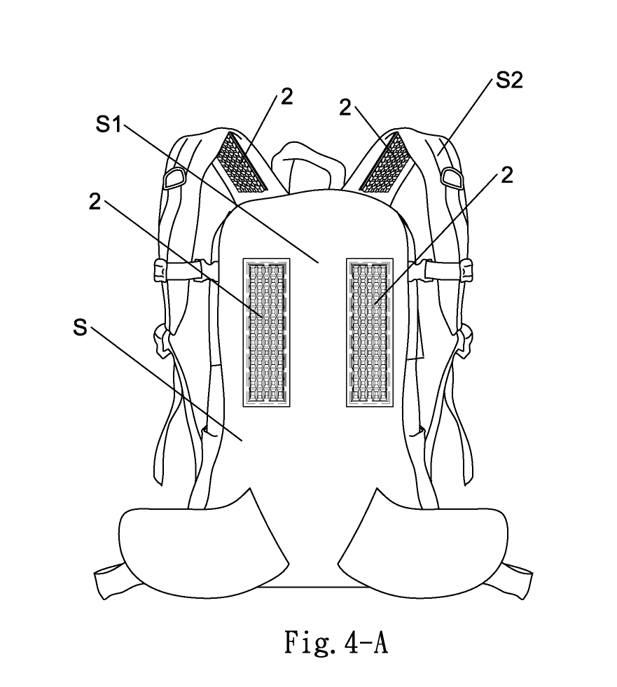

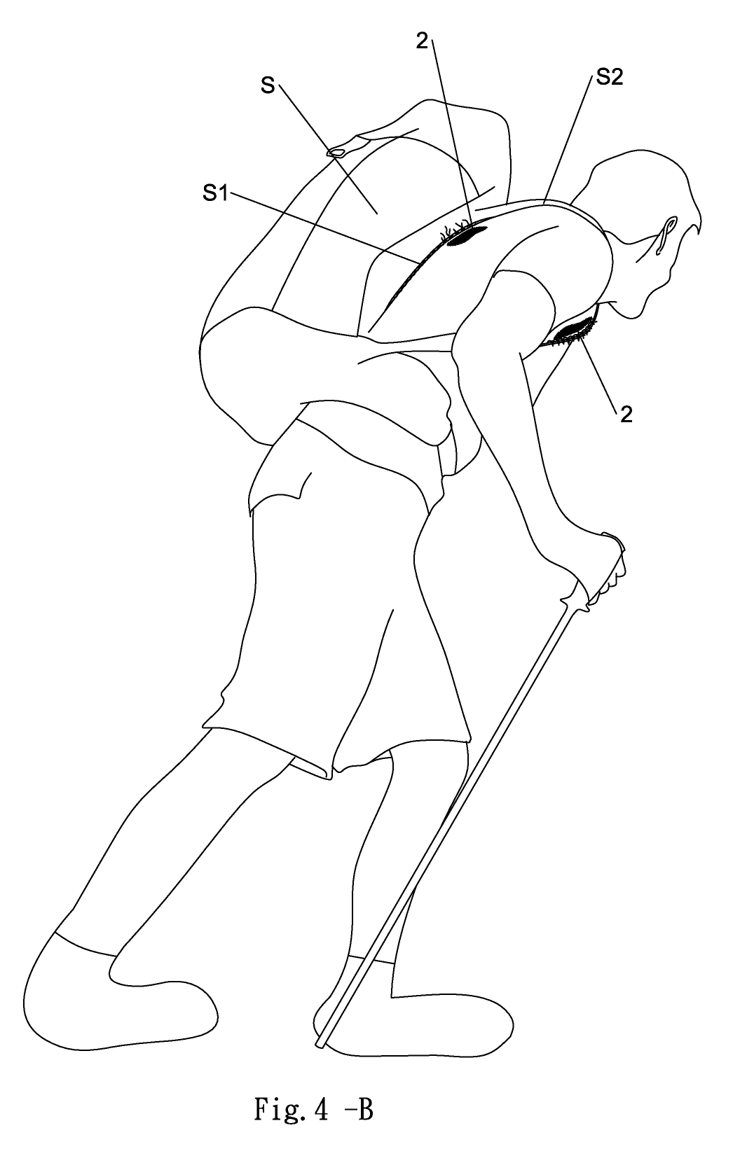

As shown in FIG. 3-A, FIG. 3B and FIG. 3C, when the cushion 2 is attached to or sewn to a backpack (for example, the rear S1 of a backpack S as shown in FIG. 4-A and shoulder belts S2 as shown in FIG. 4-B), the cushion 2 is contact with the user to absorb vibration and the face fabric 23 of the cushion 2 is able to absorb the heat and to exhaust perspiration P of the user.

When the user acts to compress the middle foam pad 22 (as shown in FIG. 3-B, the cushion 2 is in a flat compressed state), the air A initially stored between the face fabric 23 and the bottom fabric 21 will be exhausted through the exhaust apertures 231 of the cushion 2 to expel the heat absorbed by the face fabric 23 sideward, such that the cushion 2 can expel heat and moisture quickly and automatically to provide a comfortable effect.

When the middle foam pad 22 is not compressed, the cushion 2 will restore its original thickness as shown in FIG. 3-C. During the restoration of the cushion 2, the surrounding outside cool and dry air A is inhaled through the exhaust apertures 231 to be stored between the face fabric 23 and the bottom fabric 21 to preventing the contact area of the cushion 2 from stuffiness.

During compression and restoration of the foam pad 22, the air A is exhausted and inhaled repeatedly to exhaust hot air and to inhale cool and dry. The face fabric 23 is contact with the user direct to absorb the perspiration of the user, and then the perspiration is exhausted quickly. The contact area of the cushion 2 relative to the user can be kept dry and comfortable.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A cushion capable of exhausting heat and moisture, comprising:
a bottom fabric, the bottom fabric being airproof;
a foam pad, the foam corresponding in shape to the bottom fabric, the size of the foam pad being slightly smaller than that of the bottom fabric, the foam pad being disposed on top of the bottom fabric; and
a face fabric able to absorb moisture and to exhaust perspiration, the face fabric being disposed on top of the foam pad, the face fabric and the bottom fabric being connected to form a peripheral lamination so that the foam pad is enclosed between the face fabric and the bottom fabric to constitute the cushion having a certain thickness, the cushion having a plurality of air exhaust apertures close to the peripheral lamination of the face fabric and the bottom fabric, thereby, the face fabric being adapted to absorb heat and to exhaust perspiration of a user, during compression and restoration of the foam pad, air being exhausted and inhaled through the exhaust apertures of the cushion to expel the heat absorbed by the face fabric.

2. The cushion capable of exhausting heat and moisture as claimed in claim 1, wherein the foam pad has a lumpy top portion which is adapted to increase the volume of air to enhance compression.
